(19) United States
(12) Patent Application Publication
(10) Pub. No.: US 2007/0025001 A1
(43) Pub. Date: Feb. 1, 2007

(54) COLOR WHEEL DRIVING DEVICE

(75) Inventors: Satoshi UEDA, Minami-ku, Kyoto (JP); Tadayuki KANATANI, Minami-ku, Kyoto (JP)

Correspondence Address: NIDEC CORPORATION;c/o KEATING & BENNETT, LLP, 8180 GREENSBORO DRIVE, SUITE 850, MCLEAN, VA, 22102, US

(73) Assignee: NIDEC CORPORATION, Minami-ku (JP)

(21) Appl. No.: 11/460,107

(22) Filed: Jul. 26, 2006

(30) Foreign Application Priority Data
Jul. 26, 2005 (JP) 2005-215436

(51) Int. Cl. G02B 7/00

(52) U.S. Cl. 359/892

(57) ABSTRACT

A motor for driving a color wheel includes a rotor unit whose center of gravity is axially arranged between an upper bearing portion and a bottom bearing portion of a sleeve. The motor includes a rotor hub, in which the axial direction from an upper surface of the rotor hub and an upper surface of a clamper is relatively large. Minus balancing is applied on a radially outside portion of the upper surface of the rotor hub and on the upper surface of the clamper. As a result, an excessive load is not applied to the bearing assembly of the motor so that rotation of the motor is stabilized and bearing life is prolonged.

### BACKGROUND OF THE INVENTION

1. Field of the Invention

The present invention generally relates to a color wheel driving device.

2. Description of the Related Art

A single-plate type projector unit using Digital Light Processing (DLP) includes a color wheel having a plurality of color filters, each of which passes a different color light beam, and includes a color-wheel driving device that rotates the color wheel. In this projector unit, the light beam is irradiated from a light source to the color wheel, and a light beam in a suitable frequency band is obtained one after another by rotating the color wheel and is projected onto a micro mirror device. The micro mirror device reflects the light beam to guide it onto a screen. As a result, an image is projected onto the screen. In a conventional color-wheel driving device, the center of gravity of the driving device is arranged axially upward from a bearing assembly of the motor of the driving device.

In the color wheel device, a motor of the driving device is arranged in a transverse manner such that the color film of the color wheel receives the light irradiated from the light source. In the configuration mentioned above, a rotation axis of the motor is perpendicular to a direction of gravity, so that the shaft is biased in the direction of gravity and so that a force in the direction of gravity is applied to the bearing assembly. When the center of gravity is arranged axially upward from the bearing assembly, the overhang load is applied to the bearing assembly. As a result, an excessive load is applied to the bearing assembly, and the bearing life is shortened.

Furthermore, in the conventional driving device, the bearing assembly can be damaged further because of vibration or run-out caused when the rotation of the motor is not stabilized.

In general, it is possible to arrange more color filters having different colors in the color wheel by expanding an outer diameter of the color wheel. By using the color wheel mentioned above, it is possible to provide a high-resolution image while the rotational speed of the color wheel remains low. Therefore, it is possible to provide high resolution images while the rotational speed of the motor stays low. However, expanding the outer diameter of the color wheel makes the rotation of the motor unstable. On the one hand, the outer diameter of the color wheel can be reduced in order to stabilize the rotation of the motor. On the other hand, the outer diameter of the color wheel can be expanded if the rotation of the motor is stabilized. Additionally, by stabilizing the rotation, the motor can be rotated at lower speeds while providing a high-quality image. Moreover, it will prolong the bearing life of the motor.

### SUMMARY OF THE INVENTION

In order to overcome the problems described above, preferred embodiments of the present invention provide a motor which stably rotates.

According to preferred embodiments of the present invention, a color wheel driving device includes a stationary portion, a color wheel on which a plurality of color filters of different colors are arranged in a circumferential direction, a rotor hub to which the color wheel is fixed, a bearing assembly being arranged between the rotor hub and the stationary portion and rotatably supporting the rotor hub, a rotor magnet fixed to the rotor hub, and a stator being fixed to the stationary portion and having a magnetic pole facing the rotor magnet. The bearing assembly includes a pair of bearing portions arranged in an axially direction, and a center of gravity of a rotor assembly, which includes members rotatably supported by the bearing assembly, is axially arranged between the pair of bearing portions.

With this configuration described above, vibration and run-out caused by uneven weight distribution of the rotor assembly can be controlled. Therefore, excessive load is not applied to the bearing assembly, and bearing life is prolonged.

It should be understood that in the explanation of the present invention, when positional relationships among and orientations of the different components are described as being up/down or left/right, ultimately positional relationships and orientations that are in the drawings are indicated; positional relationships among and orientations of the components once having been assembled into an actual device are not indicated.

Other features, elements, characteristics and advantages of the present invention will become more apparent from the following detailed description of preferred embodiments of the present invention with reference to the attached drawings.

### BRIEF DESCRIPTION OF THE DRAWINGS

FIG. 1 is a view schematically illustrating a projector unit according to a preferred embodiment of the present invention.

FIG. 2 is a sectional view showing an axial cross section of a motor according to a preferred embodiment of the present invention.

FIG. 3 is a view illustrating a center of gravity of the motor shown in FIG. 2 equipped with a color wheel and a clamper mounted on the motor.

FIG. 4 is a view illustrating the motor according to a preferred embodiment of the present invention whose weight balance is adjusted.

FIG. 5 is a view illustrating the motor according to another preferred embodiment of the present invention whose weight balance is adjusted, wherein the clamper is not utilized to fix the color wheel to the motor in a preferred embodiment of the present invention.

FIG. 6 is a view illustrating a rotor assembly according to a preferred embodiment of the present invention whose weight balance is adjusted.

FIG. 7 is a view illustrating the motor according to another preferred embodiment of the present invention whose weight balance is adjusted.

FIG. 8 is a view illustrating the motor according to another preferred embodiment of the present invention whose weight balance is adjusted.

### DETAILED DESCRIPTION OF THE PREFERRED EMBODIMENTS

Projector Unit

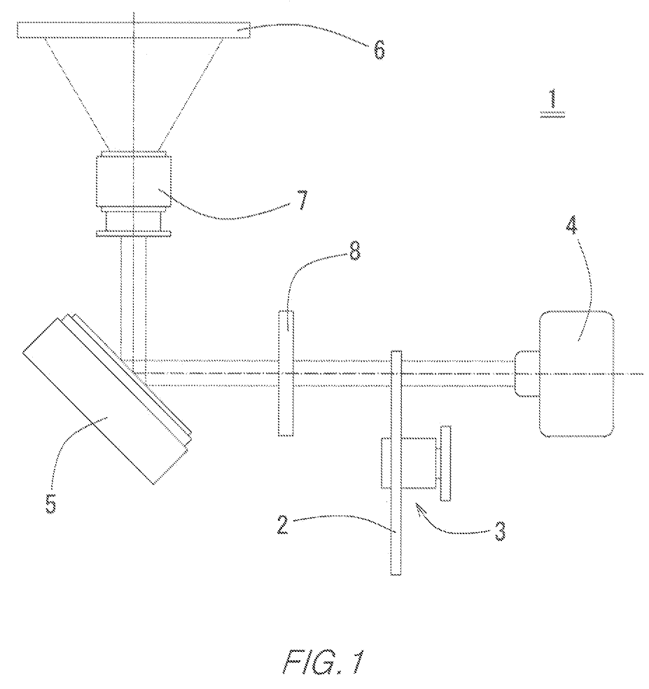

FIG. 1 is a schematic view illustrating a configuration of the projector unit 1 which projects an image onto a screen 6.

The projector unit 1 preferably includes a color wheel assembly 3, a light source 4, a digital micro mirror device (DMD) 5, and an optical projection assembly 7. The color wheel assembly 3 includes a motor and a color wheel 2 that is attached to a rotor of the motor. The color wheel 2 includes a bore into which a cylindrical portion of the rotor is inserted. The light source 4 irradiates the light to the color wheel 2, and DMD 5 reflects the light passing through the color wheel 2 to guide the light to the optical projection assembly 7 and to project the image on the screen 6.

For example, the color wheel 2 can include three different filters, one of which passes the light in a red band in a spectrum (R), one of which passes the light in a green band (G), and one of which passes the light in a blue band (B). The color wheel 2 can be circumferentially dividend into three areas by 120 degrees, and each of the R, G, and B filters are arranged in one of the three areas. The color filters of the color wheel could be arranged in other manners. The color wheel 2 is rotated by the motor at high-speed (e.g., 10,000 RPM). DMD 5 includes a plurality of micro reflecting mirrors, each of which is attitude-controllable and is arranged in a two dimensional manner. Each one of R, G, and B lights passing through the color wheel 2 is guided to each micro reflecting mirror of DMD 5 through a condenser lens 8 and is reflected into the optical projection assembly 7 or in another direction. As a result, the light incoming to the optical projection assembly 7 is projected onto the screen 6. Depending on an input signal from an external source, the attitude of the DMD 5 is changed synchronously with a rotation angle of the color wheel 2 at high speed. With the configuration mentioned above, images (composed of an R image, a G image, and a B image) projected onto the screen 6 can be changed at high speed, such that a color movie can be projected onto the screen 6.

Configuration of the Motor

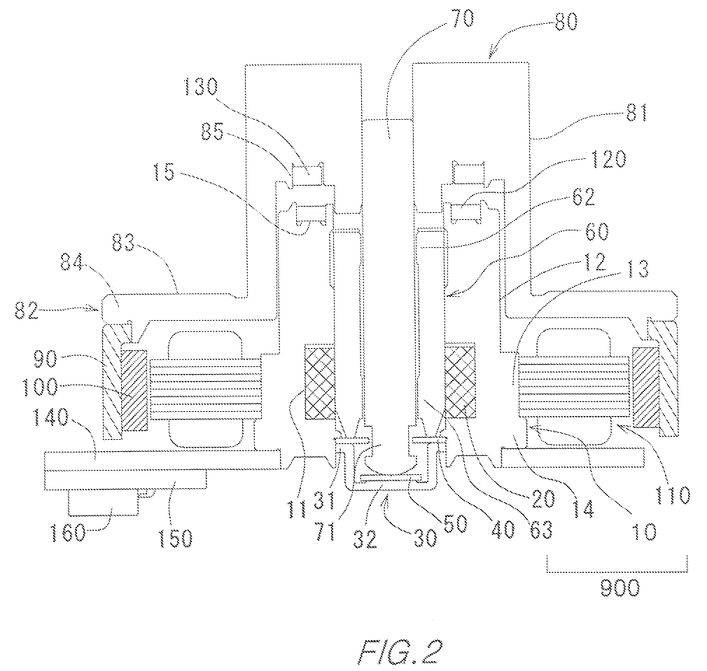

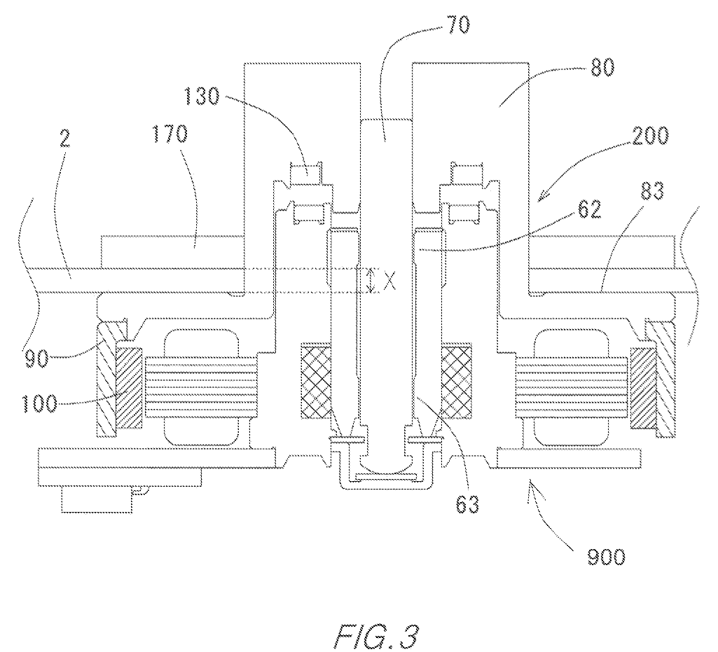

Referring to FIG. 3, the configuration of the motor installed in the color wheel assembly 3 will be described. FIG. 2 is a cross sectional view illustrating the motor of the color wheel assembly 3.

As shown in FIG. 2, a housing 10 having a substantially cylindrical shape with a through hole at a middle portion thereof is provided. At a bottom inner side of the housing 10, a circular concave portion 11 indenting in a radial direction is arranged. A felt 20 is inserted and fixed to the circular concave portion 11. Furthermore, an inner circumference cover 30, which is formed in a substantially U-shape by a deformation process such as a press process, is fixed to the bottom inner side of the housing 10. A circular washer 40 is fixed to an upper end portion 31 of the inner circumferential cover 30 by clamping it between the housing 10 and the inner circumference cover 30. Furthermore, a circular washer 50 is arranged at a middle portion 32 of the inner circumference cover 30.

A sleeve 60 made of porous material (such as porous sintered material) impregnated with lubricant oil is fixed to an inner circumferential surface of the housing 10 along the through hole. The sleeve 60 is axially positioned to abut against the circular washer 40. With the configuration mentioned above, the felt 20 is accommodated in the circular concave portion 11 provided on the housing 10.

An upper bearing portion 62 and a bottom bearing portion 63 are provided at an axially upper position and an axially bottom position of the inner circumferential side of the sleeve 60, respectively. At the upper 62 and bottom 63 bearing portions, inner diameters thereof are smaller than those other portions of the sleeve 60.

A shaft 70 is inserted into the sleeve 60 and is rotatably supported by upper 62 and bottom 63 bearing portions. A circular convex portion 71 is provided at a bottom portion of the shaft 70, and is engaged with the circular washer 40 such that the shaft 70 is securely retained.

A rotor hub 80 having a substantially cylindrical shape is fixed to an upper portion of the shaft 70. The rotor hub 80 includes an outer cylindrical portion 81 and an outwardly extending portion 82 extending in a radially outward direction. The color wheel 2 (not shown in FIG. 2) is arranged on an upper surface of the extending portion 82, and the upper surface of the extending portion 82 is hereinafter referred to as a placing surface 83. A substantially cylindrical yoke 90 made of a magnetic material is fixed to a bottom side of an outer peripheral portion 84 of the extending portion 82. Furthermore, a substantially annular rotor magnet 90 made of magnetic material is fixed to a bottom side of an outer peripheral portion 84 of the extending portion 82.

The housing 10 has a three-tiered shape, and the outer diameter of the housing expands along the axial direction in three steps. In other words, the housing 10 includes three different portions whose diameters are different, and an upper portion of the housing 10, a first cylindrical portion 12, has a smaller diameter than other two portions and is arranged so as to face an inner circumferential surface of the outer cylindrical portion 81 of the rotor hub 80 with a gap maintained therebetween. A middle portion of the housing, a second cylindrical portion 13, has a diameter greater than that of the first cylindrical portion 12 but smaller than a bottom portion of the housing, a third cylindrical portion 14.

A stator 110 having an annular shape is fixed to the second cylindrical portion 13. The stator 110 is axially aligned by abutting against an upper surface of the third cylindrical portion 14. The housing 10, the sleeve 60, and the stator 110 constitute a stationary portion 900.

A substantially annular magnet 120 is fixed within an annular convex portion 15 that is indented axially downwardly from an upper end surface of the housing 10. Moreover, an annular groove 85 is indented axially upwardly from a surface of the rotor hub 80, with the surface of the annular groove 85 axially facing the annular magnet 120. Within the annular groove 85, an annular yoke 130 made of a magnetic material is fixed. The annular magnet 120 and the annular yoke 130 attract each other and generate a magnetic bias. Therefore, the rotor hub 80 is downwardly attracted and is securely retained.

Amounting plate 140 is fixed to a bottom surface of the third cylindrical portion 14 of the housing 10. The mounting plate 140 is attached to the predetermined portion of the projector unit 1 (shown in FIG. 1) such that the motor is arranged at a predetermined position in the projector unit 1. Furthermore, a circuit board 150 for controlling the rotation of the motor is fixed to the bottom surface of the mounting plate 140. A connector 160 for connecting the stator 110 and the exterior parts (not shown) is fixed on the circuit board 150 by solder or by any other suitable fixing method.

Electric current from an external power source is provided to the stator 110 through the connector 160, and a magnetic field is generated around the stator 110. The magnetic field interacts with the rotor magnet 100, and the motor is rotary driven.

Principal Portion

1) Center of gravity

FIG. 3 is a view illustrating a motor shown in FIG. 2 with the color wheel 2 and the clamper 170. The “X” shown in FIG. 3 is the center of gravity of the rotor unit, including the color wheel 2 and the clamper 170.

As shown in FIG. 3, the color wheel 2 is arranged on the placing surface 83 of the rotor hub 80. The color wheel 2 is fixed on the placing surface by the clamper 170 which abuts against the upper surface of the color wheel 2. Hereinafter, an assembly defined by the shaft 70, the rotor hub 80, the yoke 90, the rotor magnet 100, the annular yoke 130, the color wheel 2, and the clamper 170 is referred to as a rotor assembly 200. The rotor assembly 200 rotates relative to the stationary portion 900. If the motor of the color wheel driving assembly includes a fixed shaft instead of shaft 70, the shaft does not constitute the rotor assembly 200.

According to the preferred embodiments of the present invention, the center of gravity of the rotor assembly 200 is preferably arranged axially between the upper bearing portion 62 and the bottom bearing portion 63. If the center of gravity is arranged axially upward from the upper bearing portion 62, overhand load and momentum are applied to the upper bearing portion 62. Therefore, an excessive load is applied to the upper bearing 62. As a result, the lubricant oil leaks from the gap between the shaft 70 and the upper bearing portion 62, and the bearing life is shortened. In the worst case, the shaft 70 and an inner circumferential surface of the sleeve 60 come to contact each other, and the upper bearing portion 62 is scraped by the shaft 70. As a result, sludge can be generated between the shaft 70 and the inner circumferential surface of the sleeve 60, and the motor can be locked by the sludge. According to the preferred embodiments of the present invention, however, the overhang load is not generated because the center of gravity of the rotor assembly is arranged axially downward from the upper bearing portion 62. Furthermore, because the center of gravity is arranged axially between the upper bearing portion 62 and the bottom bearing 63, the occurrence of the momentum can be prevented. As mentioned above, the excessive load is not applied to the upper bearing portion 62 so that the bearing life is prolonged.

It is preferable that the center of gravity of the rotor assembly 200 is arranged at a position axially upward from the placing surface 83 of the rotor hub 80 and axially downward from the upper surface of the color wheel 2.

More preferably, the center of gravity of the rotor assembly 200 is arranged at an axially middle position between the upper bearing portion 62 and the bottom bearing portion 63. With the configuration mentioned above, an equal load is applied to each of the upper 62 and bottom 63 bearing portions. Thus, the shaft 70 is not inclined. As a result, it is possible to control the run out and the vibration so that the rotation of the motor is stabilized.

2-1) Preferred Embodiment Having Two-Plane Balancing

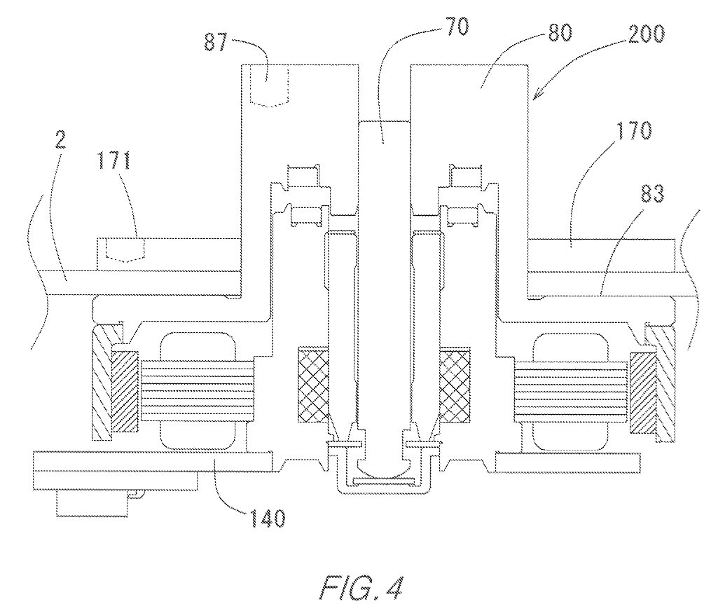

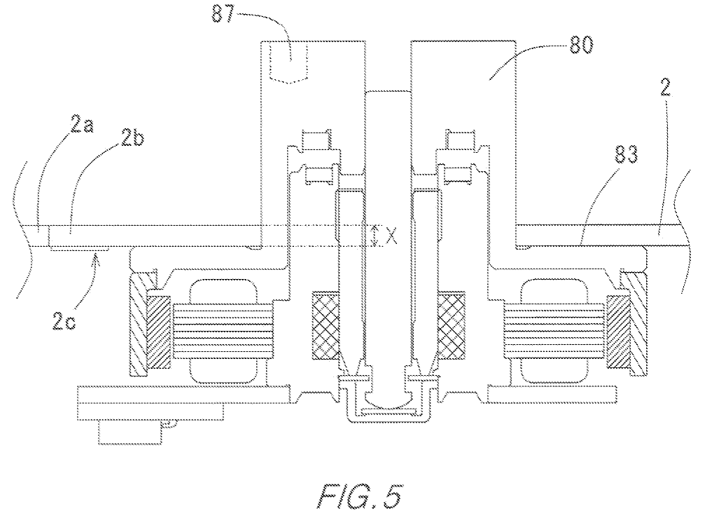

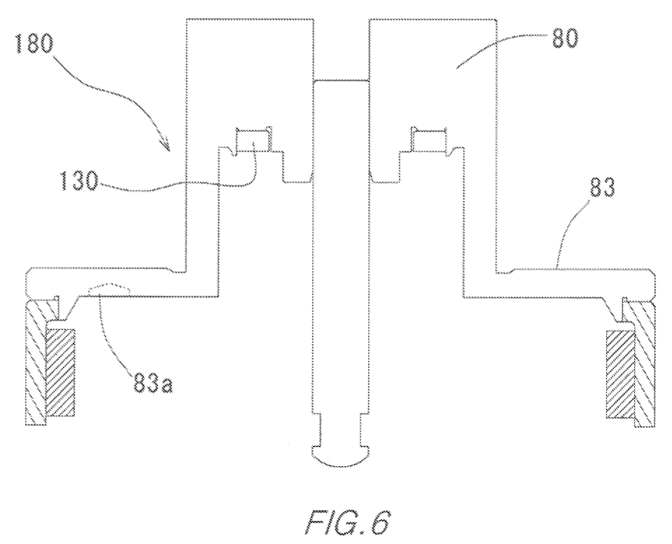

Referring to FIGS. 4 to 6, weight balancing of the rotor assembly 200 will be explained. In FIG. 4, portions where balancing is applied are illustrated by a dotted-line. FIG. 5 is a view illustrating the motor whose weight balance is adjusted, wherein the clamper is not used to fix the color wheel 2 to the motor. FIG. 6 shows portions of the rotor assembly 200 where balancing is applied by a dotted-line.

As shown in FIG. 4, the weight balance of the rotor assembly 200 is adjusted by two-plane balancing, in which the weight balance of the rotor assembly 200 is adjusted at a radially outer side portion 87 of the upper surface of the rotor hub 80 and an upper surface 171 of the clamper 170. In other words, the first balance adjustment and the second balance adjustment are performed at predetermined positions of the rotor assembly 200. In this preferred embodiment of the present invention, minus balancing, in which the radially outer side portion 87 and the upper surface 171 of the clamper 170 are drilled, grinded, or other suitable removing method is used, is performed. Plus balancing, in which balance weight is loaded on the radially outer side portion 87 of the rotor hub 80 and the upper surface 171 of the clamper 170, is not preferable for this preferred embodiment of the present invention shown in FIG. 4 because, without a wall arranged at a radially outer position from the balance weight, the balance weight can be spun off by the centrifugal force generated by rotation of the rotor assembly 200. As a result, the balance of the rotor assembly 200 becomes disproportionate so that the rotation of the rotor assembly can become unstable. In this preferred embodiment of the present invention, the balance of the motor is adjusted by minus balancing. Therefore, it is possible to provide the motor whose balance is adjusted semi-permanently. Furthermore, in this preferred embodiment of the present invention, minus balancing is applied to the upper side of the rotor hub. Therefore, it is not necessary to upend the motor to perform minus balancing, so that the efficiency of the minus-balancing process is improved.

Moreover, in this preferred embodiment of the present invention, the axial distance between the upper end surface 171 of the clamper 170 and the upper end surface of the rotor hub 80 is more than substantially half of that between the bottom end surface of the yoke 90 and the upper end surface of the rotor hub 80. With this configuration, the portions to which minus balancing are performed are distanced in the axial direction so that the effect of two-plane balancing is improved. In two-plane balancing, the greater the axial distance between the portions to which balancing is applied is, the more efficient the balancing will be. With a small axial distance, the effect of two-plane balancing can be diminished to the equivalent level of single-plane balancing. In this preferred embodiment of the present invention, however, the axial distance between the planes to which balancing is applied is large so that it is possible to effectively perform balancing.

As shown in FIG. 5, the weight balance of the rotor assembly 200 can be adjusted by applying balancing to the radially outer side portion 87 of the upper surface of the rotor hub 80 and an inner peripheral portion 2b of a color filter portion 2a of the color wheel 2. In this preferred embodiment of the present invention, minus balancing is applied to the radially outer side portion 87, and plus balancing is applied to the inner peripheral portion 2b of the color wheel 2. The portion located radially outward from the placing surface 83 of the rotor hub and radially inward from the color filter portion 2 is referred to as the inner peripheral portion 2b in this preferred embodiment of the present invention. A balance weight 2c is fixed to a radially outward position within the inner peripheral portion 2b. As explained above, the balance weight is arranged at the radially outward position so that the balance weight can be relatively light to get sufficient balancing effect. In this preferred embodiment of the present invention, it is preferable to use the balance weight having a light weight such as a thin sheet member. The thin sheet member can have a relatively large adhesive area, which results in fixing the thin sheet member to the color wheel securely enough to endure the centrifugal force. Furthermore, with the thin sheet member, it is possible to minimize the wind effect during the high-speed rotation.

Moreover, in this preferred embodiment of the present invention, the balance weight 2c can be fixed to the bottom surface of the color wheel 2. With this configuration, it is possible to adjust the weight balance of the rotor assembly 200 by loading balance weight to axially upward and downward positions from the center of gravity. With this configuration mentioned above, any vibration that is caused by the displacement of the center of gravity and that greatly affects the motor performance can be controlled because the run out of the center of the gravity can be adjusted by attaching the weight balance to both of axially upper and bottom surfaces.

As shown in FIG. 6, the weight balance of a rotor unit 180 is adjusted by applying minus balancing to the rotor unit 180, which includes the rotor hub 80, the yoke 90, the rotor magnet 100, and the annular yoke 130. In this preferred embodiment of the present invention, the weight balance can be adjusted by applying minus balancing to a radially outward portion 83a of the bottom surface of the placing surface 83 of the rotor hub 80. With this configuration in which the balancing is applied to the radially outward portion 83a, the effect of weight balancing is improved.

2-2) Another Preferred Embodiment of Two-Plane Balancing

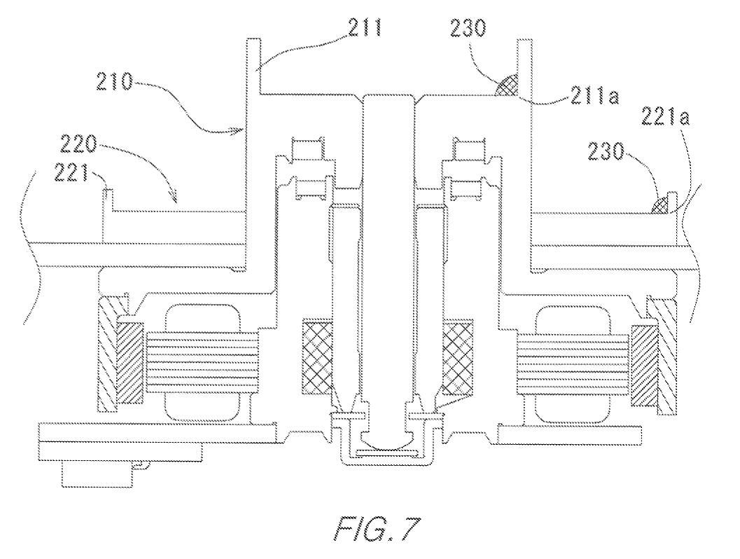

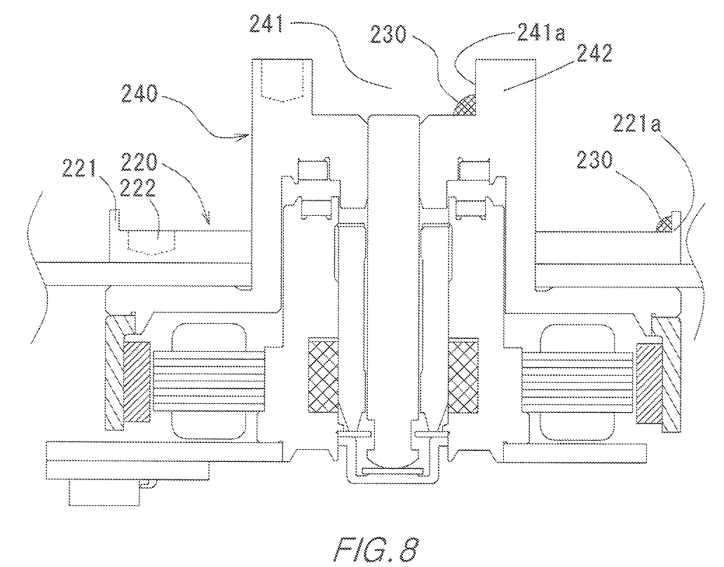

Referring to FIGS. 7 and 8, two-plane balancing according to another preferred embodiment of the present invention will be explained. A motor shown in FIG. 7, other than the shapes of the rotor hub 80 and the clamper 170, is similar to the motor shown in FIG. 3. FIG. 8 shows another preferred embodiment of the present invention in which minus balancing and plus balancing are simultaneously applied.

Hereinafter, a rotor hub and a clamper having the shapes shown in FIG. 7 are referred to as a rotor hub 210 and a clamper 220, respectively. A rotor hub having the shape shown in FIG. 8 is referred to as a rotor hub 240.

Referring to FIG. 7, the shapes of the rotor hub 210 and the clamper 220 will be explained.

At a middle portion of an upper surface of the rotor hub 210, a first annular convex portion 211 is provided. A second annular convex portion 221 is provided at a radially outward portion of the upper surface of the clamper 220. With this configuration described above, the weight balance of the rotor assembly can be adjusted by fixing the balance weight 230 at an inner peripheral portion 211a of the first annular convex portion 211 and a corner portion 221a of the upper surface of the clamper 220 and an inner circumferential surface of the second annular convex portion 221. Moreover, with walls formed on the rotor hub 210 and the clamper 220 in a manner in which the walls extends in a circumferential direction, it is possible to prevent the balance weight 230 from spinning off. As explained above, a highly reliable motor can be provided by applying plus balancing.

As shown in FIG. 8, an annular concave portion 241 is formed at an upper surface of the rotor hub 240. A radially outward portion 242 of the annular concave portion 241 has enough thickness to apply minus balancing. If plus balancing is applied, the balance weight 230 is fixed to an inner circumferential portion 241a of the concave portion 241 and is fixed to a corner portion 221a of the annular concave portion 221 of the clamper 220. If minus balancing is applied, minus balancing is applied to the upper surface of the radially outward portion 222 of the clamper 220 and the upper surface of the radially outward portion 242 of the rotor hub 240 by drilling, grinding, or other suitable methods. With this configuration discussed above, it is possible to apply both of minus balancing and plus balancing on the rotor assembly.

The balance weight according to this preferred embodiment of the present invention can be any suitable substance as long as it can be fixed to the rotor assembly. The balance weight can be adhesives, resin, metal blocks, or any other suitable material.

While preferred embodiments of the present invention have been described in the foregoing, the present invention is not limited to the preferred embodiments detailed above, in that various modifications are possible.

In the preferred embodiments of the present invention, sinter material impregnated with the lubricant oil is preferably used as the bearing. However, the bearing can be any suitable member as long as it can suitably support the rotor assembly. For example, the bearing can be a ball bearing or an air dynamic bearing.

It should be understood that the foregoing description is only illustrative of the present invention. Various alternatives and modifications can be devised by those skilled in the art without departing from the present invention. Accordingly, the present invention is intended to embrace all such alternatives, modifications, and variances that fall within the scope of the appended claims.

What is claimed is:

1. A color wheel driving device comprising:
a stationary portion;
a color wheel on which a plurality of color filters of different colors are arranged in a circumferential direction;
a rotor hub to which the color wheel is fixed;
a bearing assembly intervening between the rotor hub and the stationary portion and rotatably supporting the rotor hub;
a rotor magnet fixed to the rotor hub; and
a stator being fixed to the stationary portion and having a magnetic pole facing the rotor magnet; wherein
the bearing assembly includes a pair of bearing portions arranged in an axially direction; and
a center of gravity of a rotor assembly, which includes members rotatably supported by the bearing assembly, is axially arranged between the pair of bearing portions.

2. The color wheel driving device as set forth in claim 1, wherein the center of gravity of the rotor assembly is arranged at a substantially axially middle position of the pair of bearing portions.

3. The color wheel driving device as set forth in claim 2, wherein:
the rotor assembly has sections to which a first balance adjustment and a second balance adjustment are made such that vibration and/or run-out caused by uneven weight distribution of the rotor assembly is reduced;
the first balance adjustment, in which a portion of the rotor assembly is partially removed, is applied to a portion of the rotor hub axially distanced from the color wheel; and
the second balance adjustment, in which a portion of the rotor assembly is removed or weight is added to the rotor assembly, is applied on a portion of the color wheel radially inward from an inner peripheral portion of the color filters.

4. The color wheel driving device as set forth in claim 2, wherein:
the rotor hub includes a placing surface on which the color wheel is fixed and a cylindrical portion which is inserted into a bore formed in the color wheel;
a first annular convex portion is arranged at a radially outward position of an upper surface of the cylindrical portion;
the motor includes a clamper which fixes the color wheel onto the placing surface;
the clamper includes a second annular convex portion arranged at a radially outward position of an upper surface of the clamper; and
a balance weight is provided at a radially inner position of the first annular convex portion or at a radially inner position of the second annular convex portion or at both such that the weight balance is adjusted.

5. The color wheel driving device as set forth in claim 1, wherein:
the rotor assembly has sections to which a first balance adjustment and a second balance adjustment are made such that vibration and/or run-out caused by uneven weight distribution of the rotor assembly is reduced;
the first balance adjustment, in which a portion of the rotor assembly is partially removed, is applied to a portion of the rotor hub axially distanced from the color wheel; and
the second balance adjustment, in which a portion of the rotor assembly is removed or weight is added to the rotor assembly, is applied on a portion of the color wheel, radially inward from an inner peripheral portion of the color filters.

6. The color wheel driving device as set forth in claim 1, wherein:
the rotor hub includes a placing surface on which the color wheel is fixed and a cylindrical portion which is inserted into a bore formed in the color wheel, in which a first annular convex portion is arranged at a radially outward position of an upper surface of the cylindrical portion;
the motor includes a clamper which fixes the color wheel onto the placing surface;
the clamper includes a second annular convex portion arranged at a radially outward position of an upper surface of the clamper; and
a balance weight is provided at a radially inner position of the first annular convex portion or at a radially inner position of the second annular convex portion or at both such that the weight balance is adjusted.

7. The color wheel driving device as set forth in claim 1, wherein:
the rotor hub includes a placing surface on which an axially bottom surface of the color wheel is abutted; and
an axial position of the center of gravity of the rotor assembly is axially arranged between an axially upper surface and the axially bottom surface of the color wheel.

8. The color wheel driving device as set forth in claim 7, wherein:
the rotor assembly has sections to which a first balance adjustment and a second balance adjustment are made such that vibration and/or run-out caused by uneven weight distribution of the rotor assembly is reduced;
the first balance adjustment, in which a portion of the rotor assembly is partially removed, is applied to a portion of the rotor hub axially distanced from the color wheel; and
the second balance adjustment, in which a portion of the rotor assembly is removed or weight is added to the rotor assembly, is applied on a portion of the color wheel, radially inward from an inner peripheral portion of the color filters.

9. The color wheel driving device as set forth in claim 7, wherein:
the rotor hub includes a placing surface on which the color wheel is placed;
the rotor assembly has sections to which a first balance adjustment and a second balance adjustment are performed such that vibration and/or run-out caused by uneven weight distribution of the rotor assembly is reduced; and
the first balance adjustment, in which a portion of the rotor assembly is partially removed, and the second balance adjustment, in which a portion of the rotor assembly is partially removed or weight is added to the rotor assembly, are applied to the color wheel driving device.

10. The color wheel driving device as set forth in claim 7, wherein:
the motor includes a clamper which fixes the color wheel onto the placing surface;
the rotor assembly has sections to which a first balance adjustment and a second balance adjustment are made such that vibration and/or run-out caused by uneven weight distribution of the rotor assembly is reduced;
the first balance adjustment, in which a portion of the rotor assembly is partially removed, is applied to a portion of the rotor hub, axially distanced from the color wheel; and
the second balance adjustment, in which a portion of the rotor assembly is removed, is applied to a portion of the clamper.

11. The color wheel driving device as set forth in claim 9, wherein the first balance adjustment and the second balance adjustment are made on surfaces of the rotor hub and the clamper, both surfaces facing axially the same direction.

12. The color wheel driving device as set forth in claim 7, wherein:
the rotor hub includes a cylindrical portion which is inserted into a bore formed in the color wheel, in which a first annular convex portion is arranged at a radially outward position of an upper surface of the cylindrical portion;
the motor includes a clamper which fixes the color wheel onto the placing surface;
the clamper includes a second annular convex portion arranged at a radially outward position of an upper surface of the clamper; and
balance weight is provided at a radially inner position of the first annular convex portion or at a radially inner position of the second annular convex portion or at both such that the weight balance is adjusted.

13. The color wheel driving device as set forth in claim 1, wherein a radially outward portion of a bottom surface of a rotor unit includes a balance adjustment achieved by partially removing a portion of the rotor unit, where the rotor unit includes the rotor hub, the bearing assembly, and the rotor magnet.

14. The color wheel driving device as set forth in claim 1, wherein a center of gravity of the color wheel is axially arranged between the bearing portions.
